(19) United States
(12) Patent Application Publication
(10) Pub. No.: US 2013/0228711 A1
(43) Pub. Date: Sep. 5, 2013

(54) 3-Way Solenoid Valve

(71) Applicants: Dustin Alan Harrell, Goodlettsville, TN (US); Gregory Edward Sisk, Park Hills, MO (US); John Talbert Hughes, Hendersonville, TN (US); Aaron Kyle Fox, Carthage, TN (US); Edward Marlin Parker, JR., Nolensville, TN (US); Lyle Rudolph Donoho, Lafayette, TN (US); Dale Dawayne Dixon, Pleasant Shade, TN (US)

(72) Inventors: Dustin Alan Harrell, Goodlettsville, TN (US); Gregory Edward Sisk, Park Hills, MO (US); John Talbert Hughes, Hendersonville, TN (US); Aaron Kyle Fox, Carthage, TN (US); Edward Marlin Parker, JR., Nolensville, TN (US); Lyle Rudolph Donoho, Lafayette, TN (US); Dale Dawayne Dixon, Pleasant Shade, TN (US)

(73) Assignee: Mueller Industries, Inc., Memphis, TN (US)

(21) Appl. No.: 13/410,846

(22) Filed: Mar. 2, 2012

(51) Int. Cl. F16K 31/02

(52) U.S. Cl. 251/129.15

(57) ABSTRACT

A solenoid operated pilot valve comprising a valve assembly including a valve seat and an impact absorbing floating plunger assembly. The solenoid operated pilot valve includes an upper valve body for receiving the valve assembly and a lower valve body coupled to the upper valve body. The lower valve body defines a cavity in fluid communication with an inlet source, a primary outlet, and a secondary outlet. The upper valve body and the lower valve body are sealingly engaged to one another by primary, secondary, and tertiary sealing members. A piston assembly is disposed in the cavity and allowing selective fluid communication between the inlet source and either the primary outlet or the secondary outlet.

### FIELD

The present disclosure relates to solenoid valves, and in particular to a pilot operated three-way solenoid valve.

### BACKGROUND

This section provides background information related to the present disclosure, which is not necessarily prior art.

Solenoid actuated valves are commonly used to direct and selectively divert inlet flow between more than one delivery and/or output line. One exemplary use is with refrigeration heat reclamation, where hot refrigeration fluid or gas may be taken from the high pressure output from a compressor discharge and redirected for heat reclamation purposes. In normal operation, refrigeration fluid or gas typically flows from the compressor discharge to a downstream condenser inlet. When a solenoid actuated valve is used, the fluid or gas may be selectively diverted for heat reclamation purposes.

The operation of solenoid actuated valves with high pressure fluids and gases, however, may be prone to leakage. Leakage of refrigeration fluid or gas is highly undesirable. Accordingly, there remains a need for solenoid actuated valves with improved sealing techniques.

### SUMMARY

This section provides a general summary of the disclosure, and is not a comprehensive disclosure of its full scope or all of its features.

In one aspect of the present disclosure, a solenoid operated pilot valve is provided with a valve assembly including a valve seat and an impact absorbing floating plunger assembly. It may include a solenoid assembly configured to selectively raise and lower the impact absorbing plunger assembly. An upper valve body may be provided for receiving the valve assembly. A lower valve body may be coupled to the upper valve body and defining a cavity in fluid communication with an inlet source, a primary outlet, and a secondary outlet. The upper valve body and the lower valve body may be sealingly engaged to one another by a first sealing member, a second sealing member, and a third sealing member. A piston assembly may be disposed in the cavity, allowing selective fluid communication between the inlet source and either the primary outlet or the secondary outlet. Fluid may be directed from the inlet source to the primary outlet when the solenoid assembly is in a de-energized state, and fluid may directed from the inlet source to the secondary outlet when the solenoid assembly is in an energized state.

In another aspect, the present disclosure provides a solenoid operated pilot valve including a valve seat and an impact absorbing floating plunger assembly. The floating plunger assembly may include a slidable plunger body, a plunger pin seated within and configured to move with the plunger body, and a plunger spring biasing the plunger pin to sealingly engage the valve seat. A solenoid assembly may be provided configured to selectively raise and lower the plunger body. An upper valve body may be provided for receiving the valve assembly, and a lower valve body may be provided coupled to the upper valve body. The lower valve body may define a cavity in fluid communication with an inlet source, a primary outlet, and a secondary outlet. A piston assembly may be disposed in the cavity and allowing selective fluid communication between the inlet source and either the primary outlet when the solenoid assembly is in a de-energized state or the secondary outlet when the solenoid assembly is in an energized state.

In yet another aspect, the present disclosure provides a solenoid operated pilot valve comprising a valve assembly including a valve seat and a plunger assembly. A solenoid assembly may be provided configured to selectively raise and lower the plunger assembly. An upper valve body may be provided for receiving the valve assembly. The upper valve body may comprise a base portion that defines first and second annular grooves to retain respective first and second sealing members. A lower valve body may be configured to sealingly engage the base portion of the upper valve body and may define a third annular groove to retain a third sealing member. A cavity defined by the lower valve body may be provided in fluid communication with an inlet source, a primary outlet, and a secondary outlet. A piston assembly may be disposed in the cavity and may allow selective fluid communication between the inlet source and either the primary outlet or the secondary outlet.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a first perspective view of an exemplary three-way solenoid valve according to various aspects of the present disclosure;

FIG. 2 illustrates a second perspective view of an exemplary three-way solenoid valve according to various aspects of the present disclosure;

FIG. 3 illustrates a side plan view of an exemplary three-way solenoid valve according to various aspects of the present disclosure showing the inlet and primary outlet;

FIG. 4 illustrates a side plan view of an exemplary three-way solenoid valve according to various aspects of the present disclosure showing the inlet, primary outlet, and secondary outlet;

FIG. 5 illustrates a top plan view of an exemplary three-way solenoid valve according to various aspects of the present disclosure;

FIG. 6A illustrates a cross-sectional view of the solenoid valve taken along the line 6A-6A of FIG. 5 in a de-energized state;

FIG. 6B illustrates a cross-sectional view of the solenoid valve taken along the line 6B-6B of FIG. 5 in a de-energized state;

FIG. 7 illustrates a magnified cross-sectional view of a portion of the solenoid valve in a de-energized state as indicated by the dashed circle 7 in FIG. 6A;

FIG. 8 illustrates a cross-sectional view of the solenoid valve taken along the line 6A-6A of FIG. 5 in an energized state;

FIG. 9 illustrates a magnified cross-sectional view of a portion of the solenoid valve in an energized state as indicated by the dashed circle 9 in FIG. 8; and

FIG. 10 illustrates a perspective view of the valve housing assembly including an upper valve portion and a lower valve portion according to various aspects of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

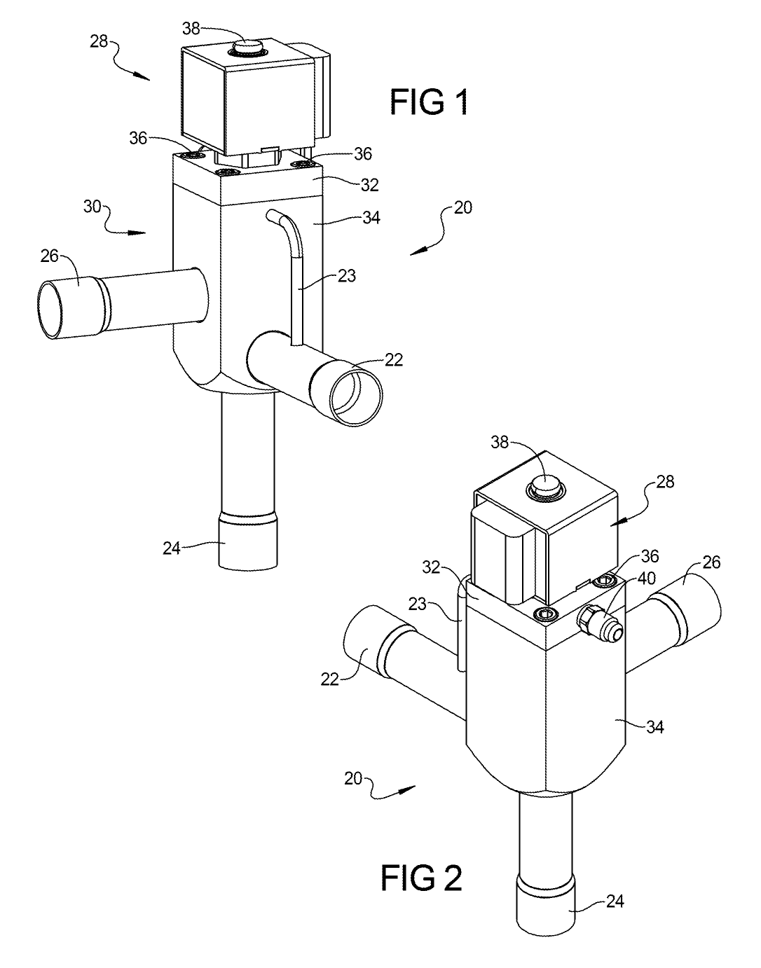

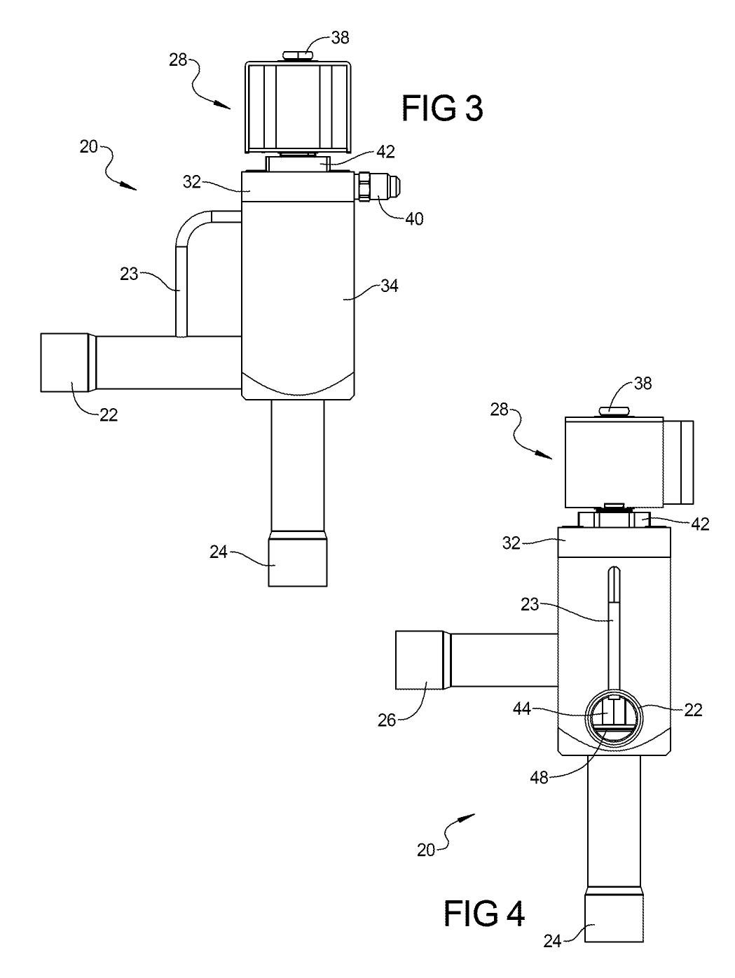

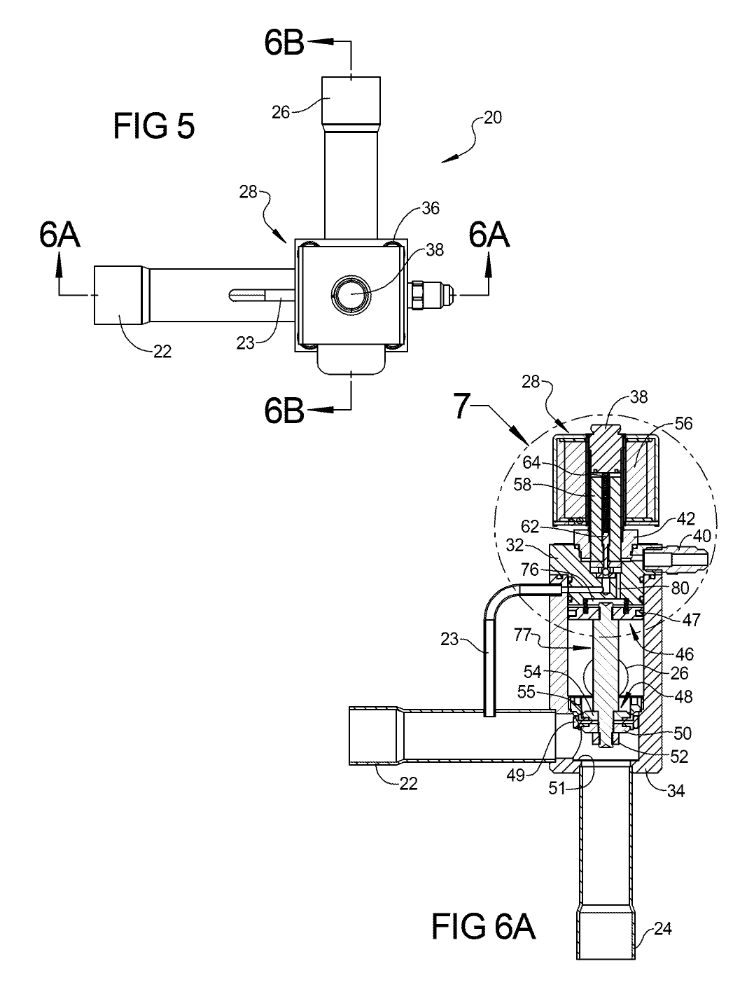

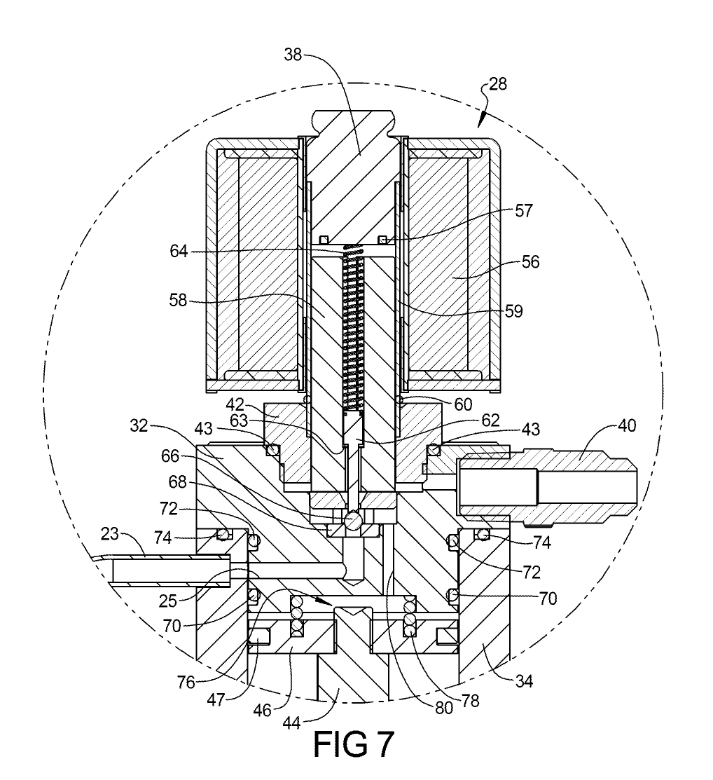

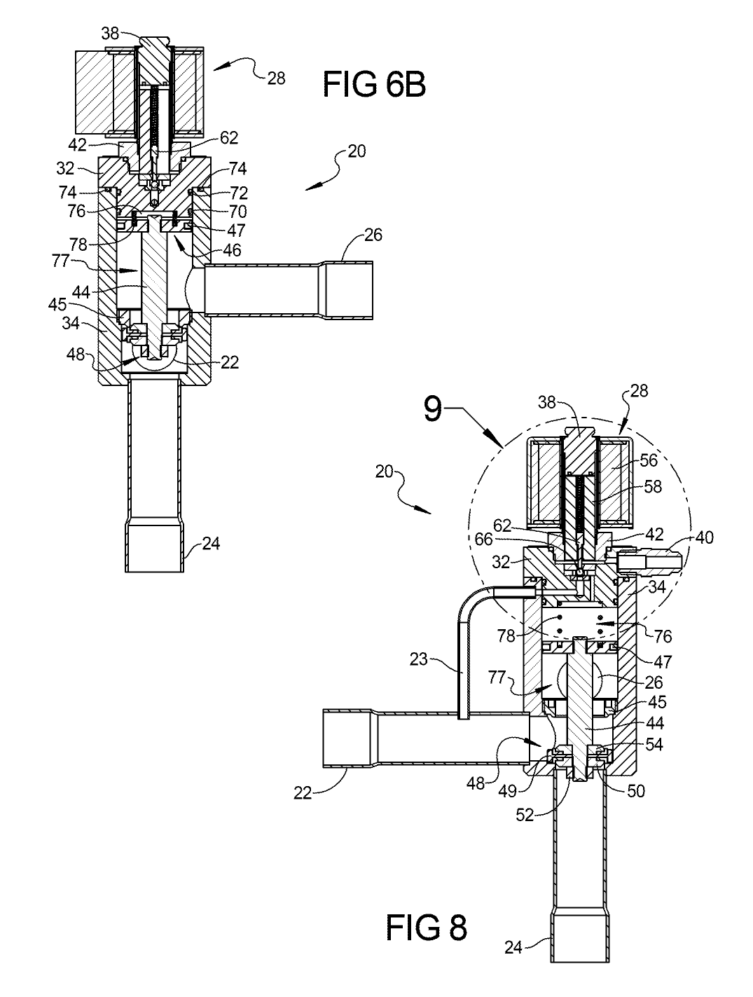

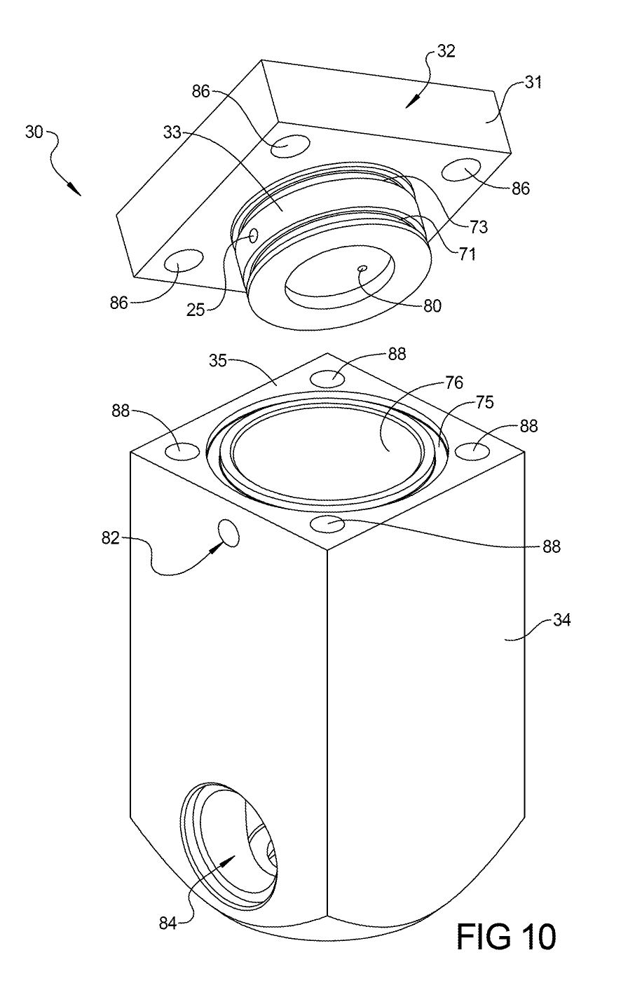

The present disclosure relates to a solenoid operated pilot valve, and more specifically, to a three-way solenoid pilot valve. As shown with reference the various figures, a solenoid assembly 20 is provided and includes an input passage 22, a first or primary outlet 24, and a second or auxiliary outlet 26. With regard to the specific illustrations provided herein, FIGS. 1 and 2 provide perspective views of the solenoid assembly 20, and FIGS. 3-5 provide corresponding plan views. FIGS. 6-9 provide various cross-section and magnified views; and FIG. 10 provides a perspective view of the valve housing assembly.

In various aspects, the three-way solenoid pilot valve 20 can be used in heat reclamation techniques related to compressor usage, and the like. By way of example, the input passage 22 may in fluid communication with a high pressure output from a compressor discharge. In normal operation, a fluid or gas, for example a refrigerant fluid or gas, may normally flow from a compressor discharge (not shown) to the inlet passage 22 where it is typically directed to a downstream condenser inlet (not shown) via the primary outlet 24. The three-way solenoid pilot valve 20 of the present disclosure may, when the solenoid is energized, selectively divert the flow of fluid from the compressor discharge to a heat reclamation unit (not shown) via the secondary outlet 26. It should be noted that the reference to the outlets as “primary” and “secondary” may be interchanged. In various aspects, however, it may be beneficial to have the discharge to the heat reclamation located at the elevated output as this may allow for free draining flow of refrigerant to the condenser. As should be apparent to one of ordinary skill in the art, the use of a three-way solenoid valve with refrigeration heat reclamation is just one of many non-limiting uses for the present technology.

The solenoid pilot valve assembly 20 may include a coil actuation assembly 28 and a valve housing assembly 30. The valve housing assembly may include an upper valve body 32 for receiving a valve assembly and a lower valve body 34 removably coupled to the upper valve body 32 with a plurality of bolts 36. The valve housing assembly 30, as well as other components of the assembly 20 may be made of brass. A capillary tube connector 23 may be provided in fluid communication between the inlet source 22 and an internal area of the valve assembly. For example, the capillary tube connector 23 may be brazed to the lower valve body 34 such that fluid or gas may be directed through a wall of the lower valve body 34 and into an internal passage 25 disposed within the upper valve body 32 leading to the valve seat 68.

The coil actuation assembly 28 may include a suitable solenoid coil 56 and a shading ring 57 as is known in the art. The coil actuation assembly 28 may utilize a removable snap-on type of design for fitting with the remainder of the solenoid assembly 20. A top plug 38 may be inserted at the top of the assembly 28 with a fastening device, such as a snap cap 39.

An impact absorbing floating plunger assembly may be provided disposed within a bottom portion of the coil actuation assembly 28. The impact absorbing plunger assembly may include a slidable plunger body 58 disposed within a plunger enclosure tube 59, and a floating plunger pin 62 disposed within the plunger body 58. An upper portion of the plunger enclosure tube 59 may couple with the top plug 38 and/or snap cap 39, while a lower portion of the plunger enclosure tube 59 may couple to a collar member 42 using a solder ring fitting 60, or other suitable fastening means. The collar member 42 may be coupled to the upper valve body 32 and a suitable sealing member 43 may be provided therebetween. In various aspects, the collar member 42 may threadedly engage the upper valve body 32.

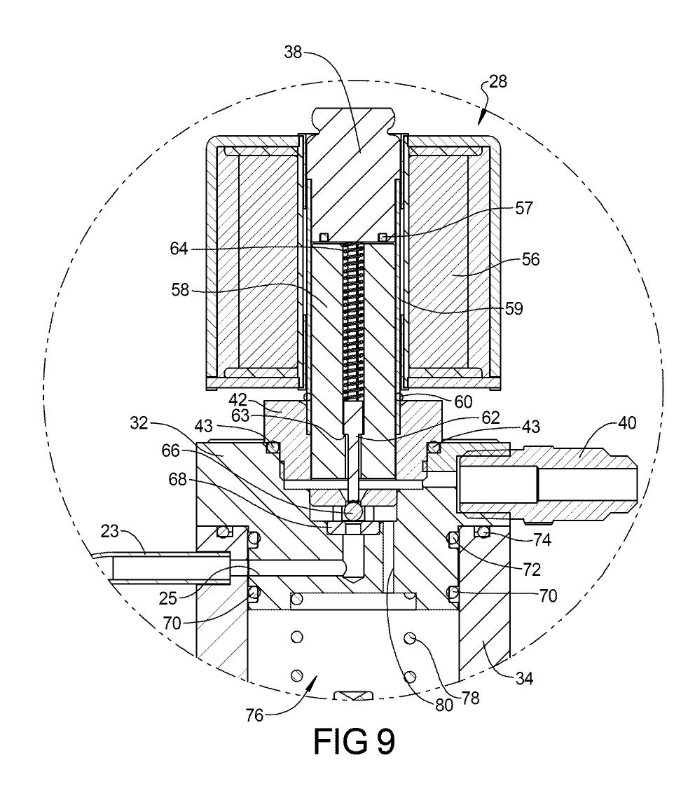

A plunger pin 62 may be seated within a slidable plunger body 58 using an appropriate annular seat 63 or other stop means such that the plunger pin 62 and is configured to move up and down corresponding with movement of with the slidable plunger body 58. A biasing member, such as a plunger spring 64, may be provided to bias the plunger pin 62 to sealingly engage a valve seat 68, as will be discussed in detail below. For example, the plunger pin 62 may be provided with a spring seat, and the plunger spring 64 may extend from the plunger pin 62 up to the top plug 38. As best shown in FIGS. 7 and 9, the plunger spring 64 is disposed between the plunger pin 62 and the top plug 38 and allows the plunger pin 62 to “float” above the valve seat 68 if necessary to absorb any impact. For example, in addition to the plunger pin 62 being configured to move up and down with corresponding movement of the plunger body 58, it is also able to independently move in an upwards direction, i.e., temporarily lift off of the valve seat 68 due to unexpected pressure fluctuations, without corresponding movement of the plunger body 58. Once lifted, the plunger spring 64 may then bias the plunger pin 62 back to a sealing position on the valve seat 68. Such a floating design may decrease wear and increase the life of the valve. For example, when the coil is in a de-energized state, only the mass of the plunger pin 62 and plunger spring 64, along with the force of the plunger spring 64, impacts the valve member 66. The mass of the plunger body 58 is not involved with the impact of the valve member 66 on the valve seat 68.

As shown in FIG. 7, in one non-limiting example, the end of the plunger pin 62 may be provided with a curved or substantially ball shaped pilot valve 66 structure configured to seal with the valve seat 68. In one aspect, the ball shaped pilot valve 66 may be substantially spherical in shape. The pilot valve 66 may be formed with the plunger pin 62 as one integral or monolithic component. In various aspects, the pilot valve 66 and plunger pin 62 may be formed from hardened stainless steel. It is believed the floating design of the present technology can offer various benefits to the solid plunger pressed pins of the prior art, for example, by minimizing stress and fatigue that may occur during normal cycling operations of the valve. If a solid plunger is used and inserted or press fit into a valve seat, for example, the tolerances may change over time by repeated contact with the valve seat, which may eventually increase the potential for leakage.

The upper valve body 32 may be provided with a top portion 31 and a base portion 33. As best shown in FIG. 10, the base portion 33 may be cylindrical, although other geometries may be used, with the understanding that it will provide a suitable seal with the lower valve body 34. The top portion 31 of the upper valve body 32 may be provided with a suction outlet 40 that may be connected to a location downstream of one of the primary or secondary outlets, for example, at a location near a compressor input.

The lower valve body 34 defines a cavity 77 that provides fluid communication between the inlet source 22 and either the primary outlet 24 or the secondary outlet 26. As illustrated, the lower valve body 34 may be configured to sealingly engage both the base portion 33 and top portion 31 of the upper valve body 32 with at least three sealing members 70, 72, 74. With renewed reference to FIG. 10, the base portion 33 may include a first annular groove 71 to retain a first sealing member 70 to form a primary seal. A second annular groove 73 may be provided in the base portion 33 to retain a second sealing member 72 to form a secondary seal. An upper and substantially planar surface 35 of the lower valve body may define a third annular groove 75 to retain a third sealing member 74 to form a tertiary seal. With reference to FIGS. 7, 9, and 10, the first and second annular grooves inwardly extend a distance in the Y direction of an X-Y plane, while the third annular groove inwardly extends a distance in the X direction of the same X-Y plane.

In various aspects, the sealing members 70, 72, 74 may comprise various O-rings and gaskets fabricated from known materials, such as polymers including neoprene, polytetrafluoroethylene (PTFE) or Teflon, and mixtures and combinations thereof. By way of example, the primary and secondary sealing members 70, 72 may be neoprene fabricated o-rings, and the tertiary sealing member may be a PTFE fabricated gasket.

A piston assembly may be disposed in the cavity 77 and can include a piston rod 44 coupled to an upper piston 46 including an upper piston seal 47 and a lower piston 48 including a lower piston seal 49. The lower piston 48 may be attached to the piston rod 44 with a nut 52 or other mechanical fastener. As shown, the lower piston 48 may include a lower cap surface 50 configured to sealingly engage an upper seating surface 51 adjacent the primary outlet 24, and an upper cap surface 54 to sealingly engage a lower seating surface 55 of a divider member 45 disposed within the cavity 77. The divider member 45 cooperates with the lower piston 48 to selectively seal portions of the cavity 77 and to direct flow to the appropriate outlet 24, 26 depending on the pilot valve position (i.e., the energized versus the de-energized states).

The upper piston 46 may be separated from the base portion 33 of the upper valve body 34 by a biasing member, such as a piston spring 78. The area between the upper piston 46 and the upper valve body 34 may define a piston spring chamber 76. The base portion 33 of the upper valve body 34 may include a pilot hole 80 or passageway providing fluid communication between the suction outlet 40 and the piston spring chamber 76.

With renewed reference to FIG. 10, which illustrates the valve housing assembly 30 components, the upper valve body 32 may include a plurality of bores 86 configured to mate with corresponding bores 88 formed in the lower valve body 34. Mechanical fasters, such as bolts, can be used to removably couple the valve bodies. It should be understood that the lower valve body 34 may include additional various bores to connect with the various inlets and outlets that may be used. For example, bore 82 is configured to connect with the capillary tube input 23, while bore 84 is configured to connect to inlet tube 22. Similar bores (not shown) on other sides of the lower valve body 34 may also be used for connection with the primary outlet 24 and secondary outlet 26. As should be understood to those skilled in the art, alternative designs can be used, including integrally formed inlets and outlets, without deviating from the scope of the present disclosure.

Now turning to the operation of the three-way solenoid valve assembly 20, when the coil 56 is de-energized, the valve is in a normal operation mode and high pressure gas or fluid may enter the inlet 22 and be diverted through the primary outlet 24 and to a condenser, or the like (not shown). In this mode, the plunger body 58 is in a downward, normal position as shown in FIGS. 6A, 6B and 7. The plunger spring 64 biases the plunger pin 62 down such that the ball valve member 66 sealingly engages the valve seat 68. The piston assembly is in a raised, upward position in the cavity 77 and is maintained in such position by the pressure from the incoming fluid or gas. For example, as shown in FIG. 6A, the upper cap surface 54 of the lower piston 48 engages the lower seating surface 55 of the divider 45, and the lower piston seal 49 prevents the fluid or gas from entering the secondary outlet 26, and only allowing the fluid to exit through the primary outlet 24. The pressure forces the piston spring 78 to be in a compressed state as the upper piston 46 is moved adjacent to the base portion 33 of the upper valve body 32. The piston spring chamber 76 is connected to the suction outlet 40 through the pilot hole 80. This causes a lower pressure area above the piston as compared to that below, keeping the piston assembly from shifting downward.

When the solenoid coil 56 is energized, however, the plunger body 58 is raised by magnetic force to abut with the top plug 38. The plunger pin 62 is concurrently raised by the upward movement of the plunger body 58 and the ball valve member 66 is lifted from the valve seat 68 as shown in FIGS. 8 and 9. The suction outlet 40 is closed from fluid communication with the valve. Fluid or gas from the capillary input tube 23 passes through the internal passage 25 of the upper valve body 32 and is allowed to pass through the valve to enter the piston spring chamber 76 via the pilot hole 80. The high pressure fluid or gas input, when combined with the biasing force of the piston spring 78, pushes the piston assembly downward to seal the primary outlet 24 as shown in FIG. 8. For example, the lower cap surface 50 of the lower piston 48 engages the upper seating surface 51 of the entrance to the primary outlet 24, and the lower piston seal 49 prevents the fluid or gas from entering the primary outlet 24, and only allowing the fluid or gas to exit up and out through the secondary outlet 26.

When the solenoid coil 56 is thereafter de-energized, the magnetic force no longer keeps the plunger body 58 in a raised position. The plunger spring 64 biases the plunger pin 62 back downward along with the plunger body 58 and the ball valve member 66 is reseated on the valve seat 68. Fluid from the capillary tube 23 is no longer able to pass through the internal passage 25 of the upper valve body 32 and to the valve. The suction outlet 40 opens and draws any remaining fluid from the piston spring chamber 76 out via the pilot hole 80, which raises the piston assembly upward. The upper cap surface 54 of the lower piston 48 is again biased against the lower seat 55 of the divider 45, closing access to the secondary outlet 26 and diverting fluid back to the primary outlet 24. High pressure keeps the piston assembly in the upward position until the solenoid is re-energized, or until incoming fluid or gas stops flowing to the three-way solenoid valve assembly.

If the flow of incoming fluid or gas stops, and the solenoid is de-energized, the piston assembly may fall back to the downward position. Alternatively, if suction is still provided via the suction outlet when flow of incoming fluid or gas stops, the piston assembly may remain in the upward position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A solenoid operated pilot valve, comprising:
a valve assembly including a valve seat and an impact absorbing floating plunger assembly;
a solenoid assembly configured to selectively raise and lower the impact absorbing plunger assembly;
an upper valve body for receiving the valve assembly;
a lower valve body coupled to the upper valve body and defining a cavity in fluid communication with an inlet source, a primary outlet, and a secondary outlet, wherein the upper valve body and the lower valve body are sealingly engaged to one another by a first sealing member, a second sealing member, and a third sealing member;
a piston assembly disposed in the cavity and allowing selective fluid communication between the inlet source and either the primary outlet or the secondary outlet; and
a suction outlet,
wherein fluid is directed from the inlet source to the primary outlet when the solenoid assembly is in a de-energized state, and fluid is directed from the inlet source to the secondary outlet when the solenoid assembly is in an energized state.

2. The solenoid operated pilot valve according to claim 1, wherein the impact absorbing floating plunger assembly comprises a plunger pin seated within and configured to move with a slidable plunger body.

3. The solenoid operated pilot valve according to claim 2, further comprising a plunger spring biasing the plunger pin to sealingly engage the valve seat when the solenoid assembly is in a de-energized state.

4. The solenoid operated pilot valve according to claim 2, wherein the plunger pin comprises an integral ball shaped pilot valve.

5. The solenoid operated pilot valve according to claim 1, wherein the piston assembly comprises a piston rod coupled to an upper piston and a lower piston, the upper piston being separated from the upper valve body by a piston spring and the area between the upper piston and the upper valve body defining a piston spring chamber.

6. The solenoid operated pilot valve according to claim 5, wherein the upper valve body comprises a pilot hole providing fluid communication between the suction outlet and the piston spring chamber.

7. The solenoid operated pilot valve according to claim 1, wherein the upper valve body comprises a cylindrical base portion that is received by the lower valve body and defines first and second annular grooves to retain the respective first and second sealing members, and further wherein the lower valve body comprises a top rim that defines a third annular groove to retain the third sealing member.

8. The solenoid operated pilot valve according to claim 1, wherein the first, second, and third sealing members comprise a polymer material selected from the group consisting of neoprene, polytetrafluoroethylene, and mixtures thereof.

9. The solenoid operated pilot valve according to claim 1, further comprising a capillary tube connector providing fluid communication between the inlet source and an internal area of the valve assembly.

10. The solenoid operated pilot valve according to claim 9, wherein the capillary tube connector is brazed to the lower valve body and the fluid is directed through a wall of the lower valve body and into an internal passage disposed within the upper valve body leading to the valve seat.

11. A solenoid operated pilot valve, comprising:
a valve seat;
an impact absorbing floating plunger assembly including:
a slidable plunger body;
a plunger pin seated within and configured to move with the plunger body; and
a plunger spring biasing the plunger pin to sealingly engage the valve seat;
a solenoid assembly configured to selectively raise and lower the plunger body;
an upper valve body for receiving the valve assembly;
a lower valve body coupled to the upper valve body and defining a cavity in fluid communication with an inlet source, a primary outlet, and a secondary outlet; and
a piston assembly disposed in the cavity and allowing selective fluid communication between the inlet source and either the primary outlet when the solenoid assembly is in a de-energized state or the secondary outlet when the solenoid assembly is in an energized state.

12. The solenoid operated pilot valve according to claim 11, wherein the upper valve body and the lower valve body are sealingly engaged to one another by a first sealing member, a second sealing member, and a third sealing member.

13. The solenoid operated pilot valve according to claim 11, wherein the plunger pin comprises an integral ball shaped pilot valve.

14. The solenoid operated pilot valve according to claim 11, further comprising a suction outlet, wherein the upper valve body comprises a pilot hole providing fluid communication between the suction outlet and an area between the upper valve body and the piston assembly.

15. The solenoid operated pilot valve according to claim 11, further comprising a collar assembly configured to secure the plunger body to the upper valve body.

16. A solenoid operated pilot valve, comprising:
a valve assembly including a valve seat and a plunger assembly;
a solenoid assembly configured to selectively raise and lower the plunger assembly;
an upper valve body for receiving the valve assembly, the upper valve body comprising a base portion that defines first and second annular grooves to retain respective first and second sealing members;
a lower valve body configured to sealingly engage the base portion of the upper valve body and defining a third annular groove to retain a third sealing member;
a cavity defined by the lower valve body and in fluid communication with an inlet source, a primary outlet, and a secondary outlet; and
a piston assembly disposed in the cavity and allowing selective fluid communication between the inlet source and either the primary outlet or the secondary outlet.

17. The solenoid operated pilot valve according to claim 16, wherein the first and second sealing members comprise a neoprene elastomer o-ring, and the third sealing member comprises a polytetrafluoroethylene gasket.

18. The solenoid operated pilot valve according to claim 16, wherein the plunger assembly comprises a slidable plunger body, an impact absorbing plunger pin seated within and configured to move with the plunger body; and a plunger spring biasing the plunger pin to sealingly engage the valve seat.

19. The solenoid operated pilot valve according to claim 16, wherein the piston assembly comprises a piston rod coupled to an upper piston and a lower piston, the upper piston being separated from the base portion of the upper valve body by a piston spring and the area between the upper piston and the base portion defining a piston spring chamber.

20. The solenoid operated pilot valve according to claim 19, further comprising a suction outlet, wherein the base portion comprises a pilot hole providing fluid communication between the suction outlet and the piston spring chamber.
